(19) United States
(12) Patent Application Publication
(10) Pub. No.: US 2011/0050537 A1
(43) Pub. Date: Mar. 3, 2011

(54) Antenna Formed Inside Film

(75) Inventors: Pei-Feng Wu, Taipei County (TW); Tsung-Wen Chiu, Taipei (TW); Fu-Ren Hsiao, Taipei (TW); Yun-Fan Bai, Taipei (TW)

(73) Assignee: ADVANCED CONNECTEK INC., Taipei County (TW)

(21) Appl. No.: 12/650,269

(22) Filed: Dec. 30, 2009

(30) Foreign Application Priority Data
Sep. 3, 2009 (TW) 098129706

(51) Int. Cl. H01Q 1/36; H01Q 1/12

(52) U.S. Cl. 343/878; 343/700 MS

(57) ABSTRACT

An antenna formed inside a film comprises a thin film, a radiation conductor, a supporter, a conductive paste and at least one contact terminal. The radiation conductor is arranged on the thin film. The supporter is arranged on the radiation conductor with at least one trench formed thereon. The contact terminal has a recession with a hole. The recession is inserted into the trench. The conductive paste is injected into the trench via the hole to have such a thickness that the top of the conductive paste exactly contacts the bottom of the recession. The present invention is characterized in that a conductive paste is used as a conduction medium and a buffer between the contact terminal and the radiation conductor. Thereby, the present invention can overcome the conventional problem that the radiation conductor and thin film are likely to be damaged in the fabrication process.

### BACKGROUND OF THE INVENTION

1. Field of the Invention

The present invention relates to an antenna formed inside a film, particularly to an antenna formed inside a film and containing a conductive paste.

2. Description of the Related Art

The embedded antenna has evolved from a single and narrow band system to a multi and broad band system very rapidly. Some antenna designers have proposed that the cellular phone system (having a frequency band of 850 MHz-2 GHz) should include a penta-band function. The elements of a multiband system should be miniaturized as much as possible. Such a requirement makes the realization of a multiband system more complicated. The consumers have a preference for wireless communication devices with a smooth and neat appearance. Therefore, the appearance, design and integration capability of a multiband antenna become a big challenge. The embedded antenna design also has to consider the following factors: power consumption, efficiency, return loss, and isolation.

To conceal an antenna inside a communication device, in recent years a new process has been developed to print the antenna on a plastic film. Firstly, radiation conductors and circuits are stuck to the surface of a plastic casing. Next, a thin film is printed over the radiation conductors and the circuits. Next, an embossing procedure is used to compress the thin film. Next, the semi-product is cut off and then placed inside a mold cavity. Finally, an injection-molding process is used to complete the antenna formed inside a film. The thin film coated on the abovementioned antenna is to enhance the wear resistance and chemical resistance of the radiation conductors.

However, when the contact terminals conducting electric signals are inserted into the holes of a plastic housing in the practical fabrication process, they are likely to bump the radiation conductors and the thin film because the assembler operator uses to much force. Thus, the radiation conductors may be damaged and the thin film may bulge, resulting in an antenna malfunction.

### SUMMARY OF THE INVENTION

One objective of the present invention is provide an antenna formed inside a film, which uses a soft conductive paste as the electric connection medium between the radiation conductor and the contact terminal lest the contact terminal directly impact the radiation conductor, whereby the present invention can prevent the radiation conductor and the thin film from being damaged by the impact of the contact terminal.

Another objective of the present invention is provide an antenna formed inside a film, which uses a soft metal powder-containing conductive paste as the signal transmission medium between the contact terminal and the radiation conductor, wherein the infinite deformability of the conductive paste can overcome the conventional problem that the elastic fatigue of the contact terminals makes the pins hard to extend or compress, whereby the present invention can lower the frequency of dismounting and replacing components.

To achieve the abovementioned objectives, the present invention proposes an antenna formed inside a film, which comprises a thin film, a radiation conductor, a supporter, a conductive paste and at least one contact terminal. The radiation conductor and the circuit are stuck onto the thin film. The supporter is tightly bonded to the radiation conductor by pressing, and at least one trench is formed on the supporter. The contact terminal has a recession, and the recession has a preformed hole. The recession of the contact terminal is inserted into the trench with a spacing existing between the recession and the radiation conductor. The conductive paste is injected into the spacing between the recession and the radiation conductor via the hole. The conductive paste is controlled to have such a thickness that the conductive paste does not overflow from the hole.

The present invention is characterized in the soft metal powder-containing conductive paste, which is arranged between the radiation conductor and the contact terminal. Via the soft powder-containing conductive paste, the present invention can prevent the contact terminal from bulging or damaging the radiation conductor and the thin film when the contact terminal is forcefully inserted toward the radiation conductor and the thin film. The soft powder-containing conductive paste not only buffers mechanical impact but also functions as the signal-transmission medium. As the soft powder-containing conductive paste has infinite deformability, it can overcome the elastic fatigue of the contact terminals, which makes the pins hard to extend or compress. Therefore, the present invention can increase the service life of products and lower the frequency of dismounting and replacing components.

Below, the embodiments are described in detail to make the technical contents of the present invention easily understood.

### BRIEF DESCRIPTION OF THE DRAWINGS

FIG. 1 is a sectional view schematically showing an antenna formed inside a film according to a first embodiment of the present invention;

FIG. 2 is a perspective exploded view of the antenna formed inside a film according to the first embodiment of the present invention;

FIG. 3 is a top-view assembly drawing of the antenna formed inside a film according to the first embodiment of the present invention; and

FIG. 4 is a bottom-view assembly drawing of the antenna formed inside a film according to the first embodiment of the present invention.

### DETAILED DESCRIPTION OF THE INVENTION

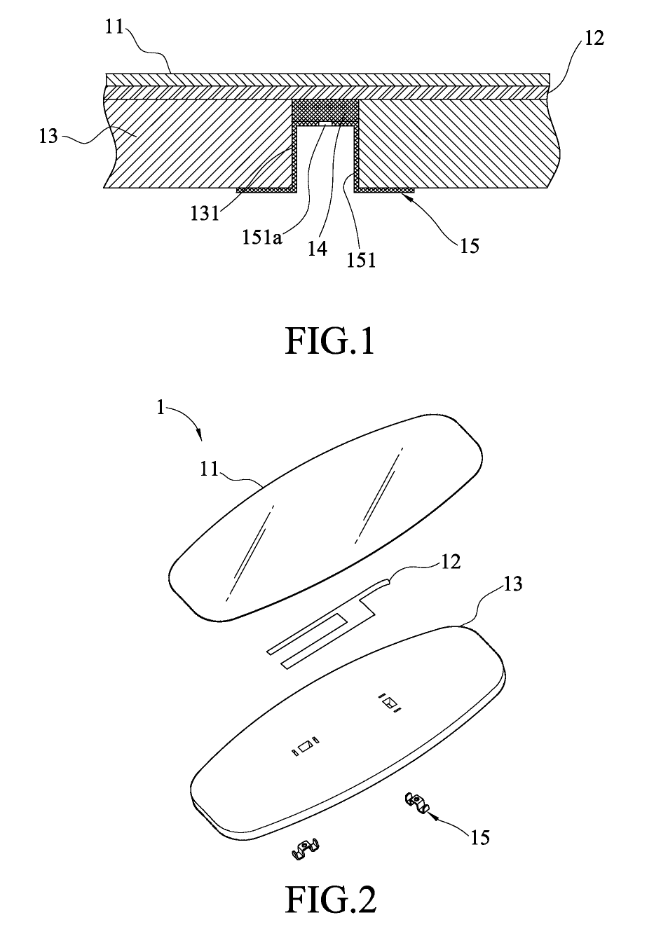

Refer to FIG. 1 a sectional view schematically showing an antenna formed inside a film according to a first embodiment of the present invention. The antenna formed inside a film of the present invention comprises a thin film 11, a radiation conductor 12, a supporter 13, a conductive paste 14 and at least one contact terminal 15. The metallic contact terminal 15 has a recession 151.

The radiation conductor 12 and the circuit are printed on the thin film 11. The thin film 11 may be a polyester film. The supporter 13 is tightly bonded to the radiation conductor 12 by pressing, and the supporter 13 has at least one trench 131. The contact terminal 15 is made of a metal sheet, and the recession 151 thereof has a preformed hole 151a. The recession 151 of the contact terminal 15 is inserted into the trench 131 with a spacing existing between the recession 151 and the patterns of the radiation conductor 12 and the circuits. Via the hole 151a, the conductive paste 14 is injected into the spacing between the recession 151 and the radiation conductor 12. In the present invention, the conductive paste 14 may be a gel, and the amount of the injected conductive paste 14 should be controlled to not overflow from the hole 151a. The thickness of the injected conductive paste 14 is about one-third the depth of the trench 131. The interface between the supporter 13 and the radiation conductor 12 must be completely sealed up lest the conductive paste 14 flow out.

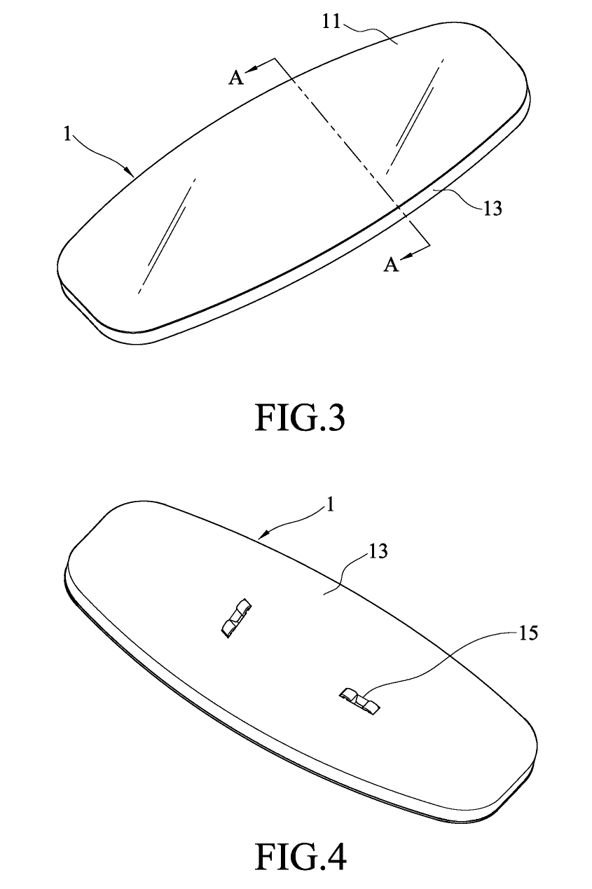

Refer to FIG. 2 and FIG. 3 respectively a perspective exploded view and a top-view assembly drawing of the antenna formed inside a film according to the first embodiment of the present invention. The present invention can apply to various wireless communication devices. In the first embodiment of the present invention, the antenna formed inside a film is applied to a mobile phone casing 1. The sectional view in FIG. 1 is taken along Line A-A in FIG. 3. In the first embodiment, the supporter 13 has two trenches 131, and the recessions 151 of two contact terminals 15 are respectively inserted into the two trenches 131. Then, the conductive paste 14 is injected into the spacings via the holes 151a to function as the medium of transmitting signals. Thereby, the present invention can implement the mobile phone to transceive signals.

In the first embodiment, the thin film 11 of the mobile phone casing 1 has a thickness of about 0.05 mm; the radiation conductor 12 has a thickness of about 0.05 mm; the supporter 13 has a thickness of about 2 mm; the contact terminal 15 is made of a metal sheet and has a total length of about 10 mm, a width of about 1 mm, and a thickness of about 0.05 mm.

Refer to FIG. 1 and FIG. 4 a bottom-view assembly drawing of the antenna formed inside a film according to the first embodiment of the present invention. After the recessions 151 of the contact terminals 15 have been inserted into the trenches 131 of the supporter 13, the conductive paste 14 is injected into the spacings between the supporter 13 and the radiation conductor 12 via the holes 151a to function as a buffer lest the antenna structure be damaged when the contact terminals 15 are forcefully inserted toward the radiation conductor and the thin film.

The above description proves that the present invention possesses utility, novelty and non-obviousness and meets the condition for a patent. However, the embodiments described above are only to exemplify the present invention but not to limit the scope of the present invention. Any equivalent modification or variation according to the spirit of the present invention is to be also included within the scope of the present invention.

What is claimed is:

1. An antenna formed inside a film, comprising
a thin film;
a radiation conductor arranged on said thin film;
a supporter arranged on said radiation conductor with at least one trench formed thereon;
a conductive paste injected into said trench of said supporter; and
at least one contact terminal having a recession inserted into said trench to contact said conductive paste.

2. The antenna formed inside a film according to claim 1, wherein said thin film is made of a polyester film Mylar.

3. The antenna formed inside a film according to claim 1, wherein an interface between said supporter and said radiation conductor are completely sealed up.

4. The antenna formed inside a film according to claim 1, wherein said conductive paste is injected into said trench of said supporter to have a thickness of about one-third a depth of said trench.

5. The antenna formed inside a film according to claim 1, wherein said conductive paste is a gel-like material.

6. The antenna formed inside a film according to claim 1, wherein said recession of said contact terminal has a hole.

7. The antenna formed inside a film according to claim 6, wherein said conductive paste is injected into said trench of said supporter via said hole of said recession.

8. The antenna formed inside a film according to claim 1, wherein said contact terminal is made of a metal sheet.
